(19) United States
(12) Patent Application Publication
(10) Pub. No.: US 2020/0306709 A1
(43) Pub. Date: Oct. 1, 2020

(54) MIXER

(71) Applicant: Sulzer Mixpac AG, Haag (CH)

(72) Inventor: Paul JUTZI, Wollerau (CH)

(21) Appl. No.: 15/779,695

(22) PCT Filed: Oct. 28, 2016
(86) PCT No.: PCT/EP2016/076157

§ 371 Date: May 29, 2018

(30) Foreign Application Priority Data
Nov. 30, 2015 (EP) 15197062.1

(51) Int. Cl. B01F 15/00; B01F 5/06; B01F 13/00; B05C 17/005

(52) U.S. Cl. CPC B01F 15/00922; B01F 5/061; B01F 13/0023; B05C 17/00509; B01F 2215/006; B05C 17/0052; B01F 2215/0039; B01F 2215/0029; B05C 17/00513

(57) ABSTRACT

A mixer includes a mixer housing, a mixing element and a mixer inlet section having at least two inlets at an input side and at least two outlets at an output side. The outlets are in fluid communication with the mixing element. The inlets are sealingly connected to corresponding exit openings of a cartridge. The mixer housing includes a connection device for connecting the mixer to the cartridge by rotational movement around a longitudinal axis. An engagement element is disposed at an outer surface of the mixer housing which is accessible from the outside when the mixer is connected to the cartridge. The engagement element includes an engagement surface spaced apart from the upstream end of the mixer housing in the direction of the longitudinal axis. The engagement surface points in the direction of the upstream end of the mixer housing thereby forming an undercut.

### CROSS-REFERENCE TO RELATED APPLICATION

This application is a U.S. National Stage application of International Application No. PCT/EP2016/076157, filed Oct. 28, 2016, which claims priority to European Patent Application No. 15197062.1, filed Nov. 30, 2015, the contents of each of which are hereby incorporated herein by reference.

### BACKGROUND

### Field of the Invention

The present invention relates to a mixer for mixing together at least two components comprising a mixer housing having a longitudinal axis, an upstream end and a downstream end, a mixing element arranged at least partly within the mixer housing, a mixer inlet section having at least two inlets disposed at an input side and at least two outlets disposed at an output side, wherein each of the at least two inlets is in fluid communication with one of the at least two outlets and wherein the outlets are in fluid communication with the mixing element, wherein the inlets are configured to be sealingly connected to corresponding exit openings of a cartridge comprising the at least two components, wherein the mixer housing comprises a connection device for connecting the mixer to the cartridge by rotational movement around the longitudinal axis, and wherein an engagement device is disposed at an outer surface of the housing which is accessible from the outside when the mixer is connected to the cartridge. The invention further relates to a dispensing apparatus comprising a multi-component cartridge and a mixer of the present invention as well as the use of a mixer of the present invention to dispense components from a multiple-component cartridge via the mixer.

### Background Information

A wide variety of ways of dispensing two-component masses from cartridges is known in the prior art. The materials to be dispensed are typically a matrix material and a hardener. Two-component materials are typically used as impression materials, e.g. on the formation of dental impressions, as a cement material for prosthetic restorations, as a temporary cement for trial cementing restoration or for cementing temporary crowns. Further applications of two-component materials are in the building industry where they are e.g. used as a replacement for mechanical joints that corrode over time. Adhesive bonding can be used to bond products such as windows and concrete elements. The use of multi-component protective coatings, for example moisture barriers, corrosion protection and anti-slip coatings is also becoming increasingly common.

The filled cartridges come in different ratios referred to as 1:1, 2:1, 4:1 and 10:1 etc., the numbers specifying the ratios of the amounts of each of the two materials that are to be dispensed. The reason for these different ratios is to allow a wide variety of different compositions to be mixed and dispensed. For example some compositions require more hardener and some require less hardener. Also some compositions require more mixing.

Static mixers, also referred to as mixing tips, are generally known from the prior art. The static mixers are adapted to mix the compositions as they exit the cartridge. In this respect different length and different diameter mixing tips are provided to ensure a thorough through mixing of the various two-component mixtures. The mixing tips typically have an insert resembling e.g. an open spiral which forces the two-components into contact with one another and exerts forces on them causing them to mix. Besides static mixers there exist also dynamic mixers in which the insert is driven to rotate around its longitudinal axis to achieve the mixing of the components.

The tight sealing connection between the inlets of the mixer inlet section and the outlets of the cartridge is usually achieved by a tight engagement of inlet tubes of the mixing inlet section and corresponding outlet tubes of the cartridge. The connection device for connecting the mixer to the cartridge by a rotational movement around the longitudinal axis usually comprise a bayonet connection device or a threaded connection device. By these connection devices, it is ensured that the mixer is firmly pushed onto the cartridge and that the inlets of the mixer inlet section and the outlets of the cartridge are firmly put together in a tight fit.

### SUMMARY

Due to this tight sealing connection of the inlets of the mixer inlet section and the outlets of the cartridge there is the problem that removing the mixer from the cartridge can be difficult. Due to high friction forces between the inlets of the mixer inlet section and the outlets of the cartridge the mixer is firmly connected to the cartridge even after the rotational connection device is released. In addition, since the used components are often adhesives or have at least a partial adhesive character the tight connection between the mixer and the cartridge is even strengthened so that high forces are necessary to pull off the mixer from the cartridge. An additional problem is that on the outer surface of the mixer housing usually engagement elements are disposed which ensure a good grip for turning the rotational connection device. These engagement elements comprise for example ribs on the outside of the mixer housing extending in the axial direction. While these engagement elements are optimized to transfer forces for a rotational movement of the mixer housing they are counterproductive for pulling off the mixer from the cartridge in an axial direction.

It is therefore an object of the invention to provide a mixer of the initially mentioned type which can be easily removed from a cartridge.

This object is satisfied by a mixer having the features described herein.

In particular the engagement elements of this mixer comprise an engagement surface spaced apart from the upstream end of the mixer housing in the direction of the longitudinal axis, wherein the engagement surface points in the direction of the upstream end of the mixer housing thereby forming an undercut. By providing an engagement surface pointing in the direction of the upstream end of the mixer housing and forming an undercut pointing in this direction high axial forces in the downstream direction can be transferred to the mixer housing. Even if the mixer is firmly connected to the cartridge by a tight fit of the inlets of the mixer inlet section and the outlets of the cartridge, after opening the rotational connection between the mixer and the cartridge the mixer can be easily pulled off from the cartridge by engaging the engagement surface of the engagement elements forming the undercut and pulling the mixer in the downstream direction. Thereby, the undercut avoids slipping of the fingers of the user along the outside of the mixer housing in the axial direction and ensures that the whole force applied by the user is used to release the connection between the inlets of the mixer inlet section and the outlets of the cartridge.

The engagement elements can preferably be integrally formed with the mixer housing. In particular, the mixer housing as well as the engagement elements may be produced in an injection molding process.

Further, in addition to the inventive engagement elements improving the axial removal of the mixer the mixer housing can comprise regular engagement elements which improve a rotational movement of the connection device. These regular engagement elements can for example comprise ribs which extend in the axial direction and which can also be integrally formed with the mixer housing. These regular engagement elements can in particular also be formed in the same injection molding process as the mixer housing and the inventive engagement elements.

In an embodiment of the invention, the engagement elements comprise at least one protrusion and/or at least one recess. The at least one protrusion and the at least one recess comprise the engagement surface which points in the direction of the upstream end of the mixer housing thereby forming the desired undercut for an improved grip of the mixer in the axial direction.

Preferably, the protrusion and/or the recess can be at least partially ring-shaped or completely ring-shaped. A partially ring-shaped or completely ring-shaped engagement elements provides a very simple configuration of the mixer. In addition, the effect of such an engagement mean is very easily understood by the user.

Further preferably, the engagement elements can comprise a plurality of protrusions and/or of recesses. Thereby, the protrusions and/or the recesses can be spaced apart in the direction of the longitudinal axis of the mixer housing. By providing a plurality of protrusions and/or of recesses the grip of the mixer in the axial direction is further improved since a slipping of the fingers even over only a part of the mixer housing is prevented.

According to a further embodiment of the invention the engagement elements comprise at least one rib, pin, post, groove and/or dimple, preferably a plurality of ribs, pins, posts, grooves and/or dimples or a combination thereof. All of these types of engagement elements can be easily formed integrally with the mixer housing and in particular in the same injection molding process as the mixer housing.

Preferably the connection device can comprise a bayonet attachment device or a threaded attachment device. With the bayonet attachment device or the threaded attachment device, the connection between the mixer and the cartridge can be achieved by first putting the inlets of the mixer inlet section and the outlets of the cartridge tightly together and subsequently rotating the connection means to strengthen and finally lock the connection between the mixer and the cartridge.

According to a further embodiment of the invention, the mixer housing comprises a mixing tube and a connection section, the mixing tube containing the mixing element and the connection section comprising the connection device. The connection section can comprise a coupling ring rotatable with respect to the mixing tube. In this embodiment, the mixer housing has at least a two-part form. It is however also possible that the connection section is formed integrally with the mixing tube which can result in a one-part mixer housing.

Preferably, the engagement elements can be disposed on the connection section. This means that the same part of the mixer housing which is turned for locking the connection between the mixer and the cartridge is engaged by a user to pull off the mixer from the cartridge after having released the rotational connection.

Preferably, the engagement elements can be arranged in a downstream half of the connection section, in particular, in the region of a downstream end of the connection section. By this arrangement there is enough space disposed between the engagement elements and the upstream end of the connection section which is usually closely positioned to a downstream end of the cartridge. In this way there is enough space for the fingers of a user to grip behind the undercut formed by the engagement elements for pulling off the mixer. In addition, in this space regular engagement elements can be provided which are optimized for transferring rotational forces to the mixer housing.

In a further embodiment of the invention, the connection section has an enlarged width compared to the width of the mixing tube. This ensures an easier connection to a two-component cartridge and in addition increases forces which will be transferred to the mixer housing during the rotational movement of the connection means.

It is in principle also possible that the engagement elements are disposed on the mixing tube rather than on the connection section. This means that after having released the rotational connection the mixer can be pulled off from the cartridge by gripping the engagement elements disposed on the mixing tube and pulling in the axial direction.

In a further embodiment of the invention, the engagement elements and the connection device are arranged without overlap in the axial direction. That means the engagement elements and the connection device do not overlap in a direction parallel to the longitudinal axis of the mixer housing. In this way demolding of the mixer in an injection molding process can be simplified.

In a further aspect, the present invention relates to a dispensing apparatus comprising a multi-component cartridge, in particular a two-component cartridge, and a mixer as described in the foregoing that is connected to the multi-component cartridge. The multi-component cartridge can preferably be filled with respective components. In still a further aspect the present invention relates to a use of a mixer of the type described herein or a dispensing apparatus of the type described herein in order to dispense components from a multi-component cartridge via the mixer.

### DESCRIPTION OF THE DRAWINGS

The invention will be explained in more detail hereinafter with reference to the drawings.

FIG. 1 is a longitudinal section through a cartridge used in connection with a mixer according to the present invention,

FIG. 2 is a top view of the cartridge of FIG. 1,

FIG. 3 is a longitudinal section through a mixer according to the invention,

FIG. 4 is a bottom view of the mixer of FIG. 3, and

FIGS. 5 to 18 are different embodiments of a mixer according to the invention.

### DETAILED DESCRIPTION OF THE EMBODIMENTS

In the following the same reference numerals will be used for parts having the same or equivalent function. Any statements made having regard to the direction of a component are made relative to the position shown in the drawing and can naturally vary in the actual position of application.

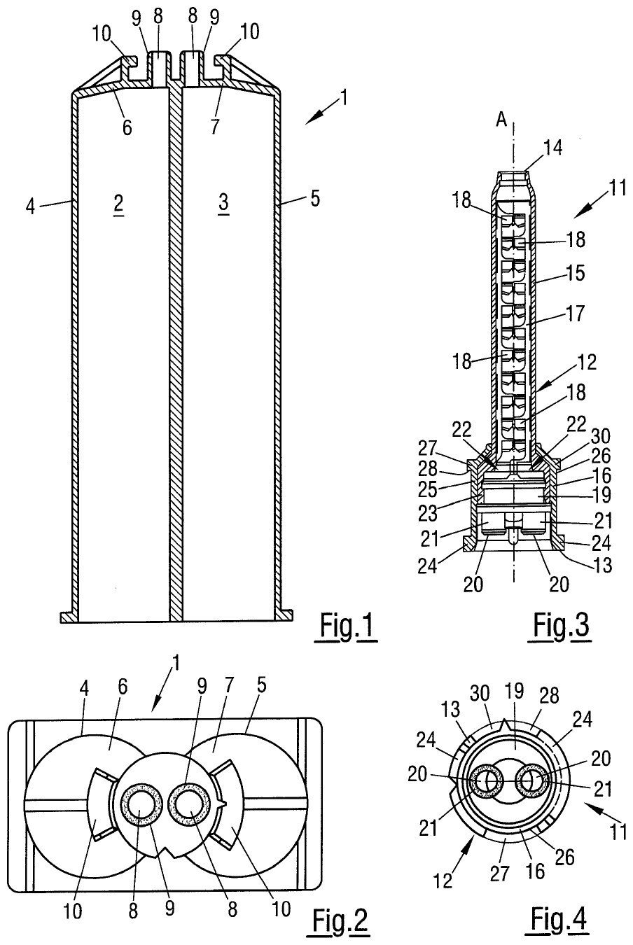

FIG. 1 shows a two-component cartridge 1 comprising two chambers 2, 3 each of which is surrounded by a cartridge wall 4, 5. Each chamber 2, 3 has an essentially cylindrical shape as it can be seen in FIG. 2. Both chambers 2, 3 are arranged in parallel to form a side-by-side two-component cartridge.

Each chamber 2, 3 has an end face 6, 7 in which exit openings 8 in the form of outlet tubes 9 are provided. Adjacent to the outlet tubes 9 two bayonet prongs 10 are integrally formed with the end faces 6, 7.

The chambers 2, 3 of the two-component cartridge 1 can be filled with two different components which can be dispensed through the exit openings 8 by axially moving pistons (not shown) in a direction towards the exit openings 8.

For mixing the two components leaving the exit openings 8 a mixer 11 as shown in FIGS. 3 to 18 can be used.

The mixer 11 comprises a mixer housing 12 having a longitudinal axis A, an upstream end 13 and a downstream end 14. The mixer housing 12 further comprises a mixing tube 15 and a connection section 16 having an enlarged diameter compared to the diameter of the mixing tube 15.

In the shown examples, the mixing tube 15 and the connection section 16 are separate parts, the connection section 16 being formed as dome-shaped coupling ring which is pushed on the mixing tube 15. Due to the separate design the connection section 16 is rotatable with respect to the mixing tube 15 around the longitudinal axis A.

However, in all embodiments of the invention it is also possible that the mixing tube 15 and the connection section 16 are integrally formed, i.e. are formed in one piece. Further, all parts of the mixer 11 according to the invention and of the described cartridge can for example be formed by injection molding.

Within the mixing tube 15 a mixing element 17 comprising a plurality of mixer elements 18 arranged adjacent along the longitudinal axis A is arranged.

At the upstream end of the mixing element 17 a mixer inlet section 19 is provided. The mixer inlet section 19 can be connected to the mixing element 17 and can in particular be integrally formed with the mixing element 17. The mixer inlet section 19 comprises two inlets 20 in the form of inlet tubes 21 disposed at an input side of the mixer inlet section 19.

The mixer inlet section 19 further comprises two outlets 22 at an output side of the mixer inlet section 19 which are on the one hand in fluid communication with the inlets 20 and on the other hand with the mixing element 17. The mixer inlet section 19 is sealingly arranged within a widened portion 23 of the mixing tube 15.

As can be seen from FIG. 4, the connection section 16 as well as the inlets 20 have essentially a circular cross-section. As further can be seen from FIGS. 3 and 4 at the upstream end 13 of the connection section 16 bayonet lugs 24 are provided which correspond to the bayonet prongs 10 of the cartridge 1 for connecting the mixer 11 to the cartridge 1.

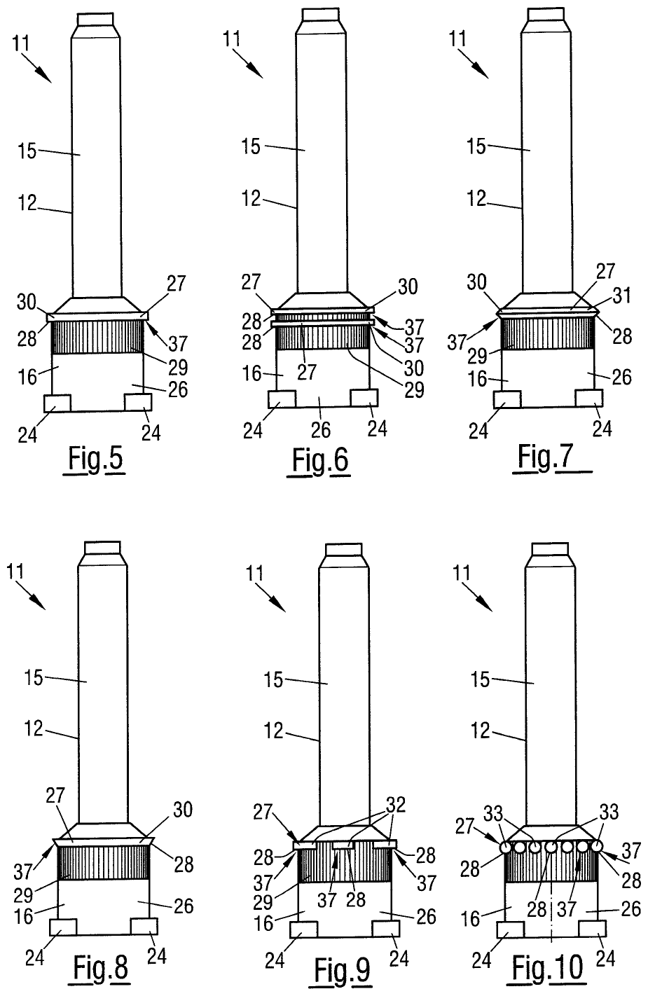

The connection section 16 comprises a cylindrical part 25 having an outer surface 26 on which an engagement means or element 27 is provided. The engagement element 27 is formed as a circumferential protrusion 30 surrounding the connection section 16 at its downstream region (see also FIG. 5).

The engagement element 27 protrudes radially outwardly from the outer surface 26 and comprises a ring-shaped engagement surface 28 which is spaced apart from the upstream end 13 of the mixer housing 12. The engagement surface 28 points in the direction of the upstream end 13 thereby forming an undercut 37 in the axial direction. That means that the engagement surface 28 forming the undercut 37 is positioned and oriented to transfer forces which act on the engagement surface 28 in the direction of the downstream end 14 directly to the remaining mixer housing 12.

The mixer 11 can be connected to the cartridge 1 by plugging the mixer 11 onto the cartridge 1 so that the inlet tubes 21 are inserted into the outlet tubes 9 of the cartridge 1. The shape and size of the inlet tubes 21 and the outlet tubes 9 are chosen such that the inlet tubes 21 are tightly fitted within the outlet tubes 9 in order to achieve a tight sealing connection between the mixer 11 and the cartridge 1. After the mixer 11 and the cartridge 1 have been plugged together the connection section 16 is turned until the bayonet lugs 24 engage the bayonet prongs 10. In this way the mixer 11 is locked onto the cartridge 1.

For removing the mixer 11 from the cartridge 1 the connection section 16 is turned in the reverse direction until the bayonet lugs 24 and the bayonet prongs 10 are disengaged. Subsequently, the mixer 11 must be pulled off from the cartridge 1 by firmly holding the connection section 16 and pulling the mixer 11 along the longitudinal axis A in the downstream direction.

Due to the tight fit of the inlet tubes 21 within the outlet tubes 9 high friction forces must be overcome in order to separate the mixer 11 from the cartridge 1.

In order to avoid the fingers gripping the connection section 16 from slipping over the outer surface 26 in the axial direction the engagement element 27 is provided. The engagement surface 28 forms an undercut 37 for the grip of the fingers and thus the mixer 11 can be pulled off from the cartridge 1 even if there is a tight fit between the inlet tubes 21 and the outlet tubes 9.

The engagement element 27 is effective even if on the outer surface 26 of the connection section 16 additional regular engagement elements are provided as they are shown in FIGS. 5 to 14 and 18. Regular engagement elements may for example comprise axially extending ribs 29 which are usually provided in known mixers to support the rotational movement of the connection section 16 around the longitudinal axis A. However, these axially extending ribs 29 provide only a good grip for turning the connection section 16 but unfortunately decrease the traction in the axial direction.

By additionally providing the engagement element 27 comprising an engagement surface 28 according to the invention the traction in the axial direction can be improved and even mixers having a tight fit can be easily pulled off from the cartridge 1.

While the engagement element 27 shown in FIG. 5 correspond to the engagement element 27 in FIG. 3 having the form of a circumferential protrusion 30, from FIGS. 6 to 18 it can be seen that a plurality of different embodiments of the engagement element 27 is possible.

According to FIG. 6 instead of one circumferential protrusion 30 two or even more such protrusions 30 can be disposed which are arranged spaced apart in the longitudinal direction on the outer surface 26 of the connection section 16.

While the protrusion 30 shown in FIGS. 3, 5 and 6 are formed as ribs having a rectangular cross section FIG. 7 shows an engagement element 27 in the form of a protrusion 30 having an essentially triangular cross section. The engagement surface 28 of this engagement element 27 as well as the corresponding downstream surface 31 are inclined with respect to the longitudinal axis A.

In the embodiment according to FIG. 8 the engagement element 27 is formed as circumferential protrusion 30 having also an essentially triangular cross section. In contrast to the embodiment of FIG. 7 only the engagement surface 28 is inclined to the longitudinal axis whereas the downstream surface 31 is arranged perpendicular to the longitudinal axis A.

According to FIG. 9 the engagement element 27 can comprise a circumferential protrusion 32 which is several times interrupted. Similarly, the engagement element 27 of the embodiment shown in FIG. 10 comprises a ring of pins 33 protruding radially outwardly from the outer surface 26.

In the embodiment according to FIG. 11 the engagement element 27 comprises a circumferential protrusion 30 similar to the protrusion 30 in FIG. 5. In contrast to the embodiment of FIG. 5 in FIG. 11 the protrusion 30 is positioned in the middle region of the connection section 16 rather than in its downstream region.

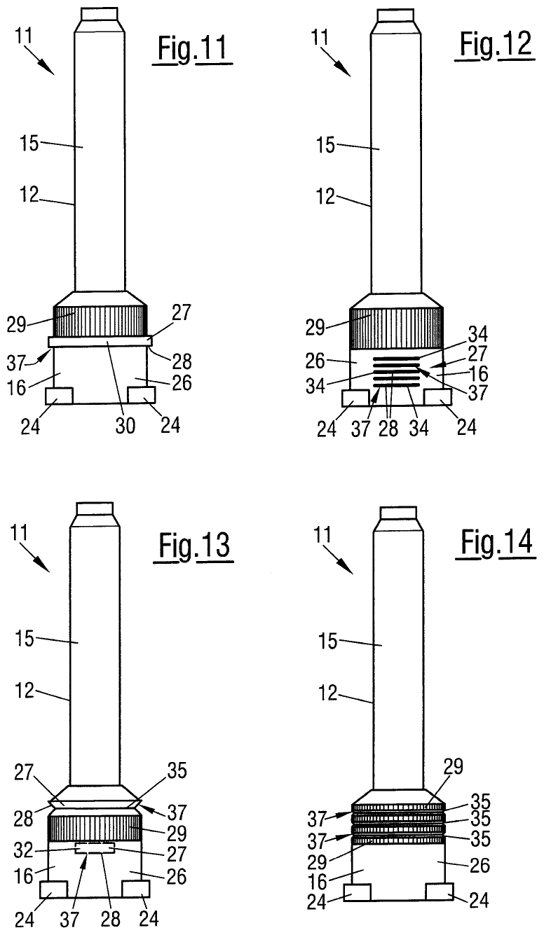

In the embodiment according to FIG. 12 a plurality of small ribs 34 are disposed in the upstream half of the connection section 16. These small ribs 34 form the engagement element 27 and are running in parallel to each other and perpendicular to the longitudinal axis A. It can further be seen that these ribs 34 may extend only over a limited sector or predefined angle, for example of approximately 90°, of the outer surface 26. In this embodiment, similar or identical ribs 34 may be disposed on the opposite side of the connection section 16. The ribs 34 are only provided within the space between the two bayonet lugs 24, i.e. the ribs 34 and the bayonet lugs 24 are arranged without overlap in axial direction. In this way demolding of the mixer 11 at the end of an injection molding process is simplified. However, it is in principle also possible that the ribs 34 are not limited to a specific angle but are running around the whole connection section 16.

According to FIG. 13 the engagement element 27 can comprise a recess 35 which can have a triangular cross section. In addition, an alternative engagement element 27 is shown in broken line. Similar to the engagement element 27 of FIG. 9 this alternative engagement element 27 is formed as partial or interrupted circumferential protrusion 32. However, this engagement element extends in circumferential direction only within the space between the two bayonet lugs 24 (as described with respect to the ribs 34 of FIG. 12). In this embodiment a similar or identical protrusion 32 may be disposed on the opposite side of the connection section 16. As already mentioned demolding of the mixer 11 at the end of an injection molding process is simplified by such an arrangement.

As shown in FIG. 14 a plurality of such recesses 35 can be disposed on the outer surface 26 of the connection section 16. The depth and width as well as the distance of these recesses can vary and can for example be in the same order as the lateral spacing of the axially extending ribs 29. This would yield a two-dimensional pattern of pyramidal spikes having each a quadratic base.

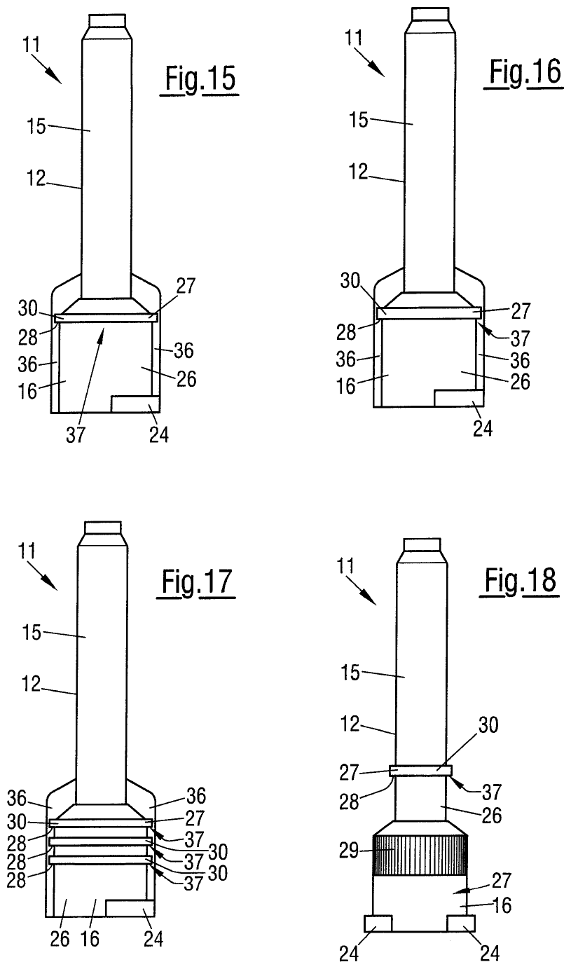

As can be seen from FIGS. 15 to 17 the regular engagement elements may comprise two flanges 36 at the outer surface 26 rather than axially extending ribs 29. The flanges 36 have a flat shape and extend in axial and radial direction. All of the aforementioned engagement elements 27 can also be provided in such embodiments having no axially extending ribs 29. Exemplarily in FIG. 15 an engagement element 27 in the form of a surrounding protrusion 30 is shown. FIG. 16 shows a similar surrounding protrusion 30 which has a greater radial width so that the outer surface of the protrusion 30 is aligned with the outer shape of the flanges 36.

In the embodiment in FIG. 17 a plurality of ring-shaped protrusions 30 as shown in FIG. 15 are arranged on the outer surface 26.

FIG. 18 shows a mixer 11 similar to the mixer 11 of FIG. 5 in which the engagement element 27 is not provided on the connection section 16 but on the mixing tube 15. Similar to the embodiment of FIG. 5 the engagement element 27 is formed as circumferential protrusion 30 which is disposed on and in particular integrally formed with the outer surface 26 of the mixing tube 15. While in FIG. 18 only one protrusion 30 is shown it should be mentioned that all types of engagement elements 27 as described in this application can be provided on the mixing tube 15.

The different embodiments of the engagement elements 27 shown in the Figures can be combined and different features like the shape, the number and the position of the respective engagement elements can be combined as necessary. Further, although the invention has been described with respect to static mixers as shown in the Figures it should be mentioned that the invention is also applicable to dynamic mixers.

1. A mixer for mixing at least two components, comprising:
a mixer housing having a longitudinal axis, an upstream end and a downstream end;
a mixing element arranged at least partly within the mixer housing; and
a mixer inlet section having at least two inlets disposed at an input side and at least two outlets disposed at an output side, each of the at least two inlets is being in fluid communication with one of the at least two outlets and the outlets being in fluid communication with the mixing element,
the inlets being configured to be sealingly connected to corresponding exit openings of a cartridge comprising the at least two components,
the mixer housing including a connection device configured to connect the mixer to the cartridge by rotational movement around the longitudinal axis, and
an engagement element disposed on an outer surface of the mixer housing which is accessible from the outside when the mixer is connected to the cartridge, the engagement element including an engagement surface spaced apart from the upstream end of the mixer housing in the direction of the longitudinal axis, the engagement surface pointing in the direction of the upstream end of the mixer housing thereby forming an undercut.

2. The mixer according to claim 1,
wherein the engagement element includes at least one protrusion or at least one recess.

3. The mixer according to claim 2,
wherein the protrusion or the recess is at least partially ring-shaped or completely ring-shaped.

4. The mixer according to claim 2,
wherein the engagement element includes a plurality of protrusions or recesses.

5. The mixer of claim 4,
wherein the protrusions or the recesses are spaced apart in the direction of the longitudinal axis of the mixer housing.

6. The mixer according to claim 1,
wherein the engagement element includes at least one rib, pin, post, groove or dimple.

7. The mixer according to claim 1,
wherein the connection device includes a bayonet attachment device or threaded attachment device.

8. The mixer according to claim 1,
wherein the mixer housing includes a mixing tube and a connection section, the mixing tube containing the mixing element and the connection section comprising the connection element.

9. The mixer according to claim 8,
wherein the connection section includes a coupling ring rotatable with respect to the mixing.

10. The mixer according to claim 8,
wherein the connection section is integrally formed with the mixing tube.

11. The mixer according to claim 8,
wherein the engagement element is disposed on the connection section.

12. The mixer according to claim 8,
wherein the engagement element is arranged in a downstream half of the connection section.

13. The mixer according to claim 8,
wherein the connection section has an enlarged width compared to a width of the mixing tube.

14. The mixer according to claim 8,
wherein the engagement element is disposed on the mixing tube.

15. The mixer according to claim 8,
wherein the engagement element and the connection device are arranged without overlap in the axial direction.

16. A dispensing apparatus comprising:
a multi-component cartridge; and
a mixer according to claim 1 connected to the multi-component cartridge, with the multi-component cartridge configured to be filled with respective components.

17. A method comprising:
operation of the mixer in accordance with claim 1 to dispense components from a multi-component cartridge via the mixer.

18. A method comprising:
operation of the dispensing apparatus in accordance with claim 16 to dispense components from a multi-component cartridge via the mixer.

19. The mixer according to claim 1,
wherein the engagement element includes a plurality of ribs, pins, posts, grooves, dimples or a combination thereof.

20. The mixer according to claim 8,
wherein the engagement element is arranged in a region of a downstream end of the connection section.
